(19) United States
(12) Patent Application Publication
(10) Pub. No.: US 2026/0046295 A1
(43) Pub. Date: Feb. 12, 2026

(54) SCALABLE FEDERATED DISTRIBUTED SECURITY ANALYTICS

(71) Applicant: Cisco Technology, Inc., San Jose, CA (US)

(72) Inventors: Thomas Leslie Wood, Fernandina Beach, FL (US); Nancy Patricia Cam-Winget, Mountain View, CA (US)

(21) Appl. No.: 19/192,327

(22) Filed: Apr. 28, 2025

Related U.S. Application Data
(60) Provisional application No. 63/682,074, filed on Aug. 12, 2024.

(51) Int. Cl. H04L 9/40

(52) U.S. Cl. CPC H04L 63/1416

(57) ABSTRACT

Techniques for federated distributed security analytics using a swarm node framework to provide a scalable way to improve efficiency and accuracy of determining and remediating security threats, while reducing computational complexity and resource usage of a system. A system may comprise node(s) executing a first engine and a second engine. The first engine may operate in a data plane and receive event data associated with security events, perform a specialized type of function, and generate two classes of output(s): (1) transformed event data output to other first engine(s) of other node(s) and (2) security signal(s) output to the second engine. The second engine may be configured to operate in a control plane. The second engine may receive input(s), including the security signal(s) and determine action(s) to perform with regard to security event(s). The second engine may output instruction(s) to other node(s) and/or derived security signal(s) to other second engine(s).

### CROSS REFERENCE TO RELATED APPLICATIONS

This application claims priority to U.S. Provisional Patent Application No. 63/682,074, filed Aug. 12, 2024, the entire contents of which are incorporated herein by reference.

### TECHNICAL FIELD

The present disclosure relates generally to network security and more specifically to utilizing a swarm architecture to provide a system for federated distributed security analytics that federates the computational load of security event detection.

### BACKGROUND

Network security is constantly evolving. With the introduction of generative artificial intelligence and large language models, malicious actors can create new ways to attach a network or penetrate network security. With the constantly evolving threat landscape, a service provider of networks can get flooded with alerts indicating potential security events across the customer networks. Techniques for analyzing are, in general, achieved through a centralized service that produces a security outcome that is then used by either the human using Security Operations Center (SOC) service, or through an API by a policy decision point to provide an actionable to be executed by an enforcement point. Further, techniques today attempt to provide convergence of data from different service to provide improved or automated security outcomes. However, existing techniques face challenges.

For instance, due to the sheer volume of alerts received (e.g., event data and telemetry data), current techniques are constrained. For instance, storage requirements for the alert data is overwhelming and lacks scalability. Further, signal to noise ratio of the data that is available versus what is really needed to detect a security event is really high. Moreover, getting a full picture of the security landscape driven by the comprehensive view afforded by a combination of logging the alerts and detecting security events incurs a time penalty due to the need to wait for a large number of events to arrive, be stored, curated and analyzed. Accordingly, current techniques lack scalability, accuracy, and require large amounts of memory and computing resources, thereby resulting in high costs to maintain.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an environment in which a swarm system may perform federated analytics and remediation, according to the techniques described herein.

FIG. 2A illustrates an example environment including example input(s) and output(s) of a transformation component of the swarm node instance, according to the techniques described herein.

FIG. 2B illustrates an example environment including example input(s) and output(s) of a control plane component of a swarm node instance, according to the techniques described herein.

FIG. 3 illustrates an example environment showing input(s) and output(s) of component(s) of a node, according to the techniques described herein.

FIG. 4A illustrates an example process for transforming event data, according to the techniques described herein.

FIG. 4B illustrates an example process for control plane processing, according to the techniques described herein.

FIG. 5 illustrates a flow diagram of an example system implementing a process to perform federated analytics according to the techniques described herein.

FIG. 6 is a computer architecture diagram showing an example computer architecture for a device capable of executing program components that can be utilized to implement aspects of the various technologies presented herein.

### DESCRIPTION OF EXAMPLE EMBODIMENTS

### Overview

The present disclosure relates generally to cybersecurity and more specifically to providing a system for scalable and federated distributed security analytics to reduce noise, memory usage, and computational complexity of security events.

A method described herein may be implemented by nodes of a swarm system of a network. The method may include receiving, by a first engine of a node, event data associated with security events from one or more other nodes in the network. The method may also include determining, by the first engine, a subset of data of the event data that meets one or more criteria. The method may include generating, by the first engine, a security signal associated with the subset of data. The method also includes receiving, by a second engine of the node and from the first engine, the security signal as input. The method may further include determining, by the second engine and based in part on the security signal, to perform an action with regard to a security event associated the security signal. The method may include outputting, by the second engine and to a second node within the network, instructions to perform the action.

Additionally, the techniques of at least the first method and the second method and any other techniques described herein, may be performed by a system and/or device having non-transitory computer-readable media storing computer-executable instructions that, when executed by one or more processors, performs the method(s) described above.

### EXAMPLE EMBODIMENTS

This disclosure describes techniques for providing a scalable, federated distributed security analytics solution.

Security Operations Centers (SOCs) are at the forefront of defending organizational IT infrastructures from an array of cyber threats. These SOCs are responsible for monitoring IT systems, identifying deviations from normal operations that may signify security incidents, and executing a series of steps to mitigate these incidents. The process, as outlined by frameworks like SANS “PICERL”, includes Identification, Containment, Eradication, and Recovery phases. Each of these phases requires meticulous manual effort by SOC analysts and incident responders, involving the collection of evidence, identification of the attack's root cause, determination of incident type and severity, isolation of affected network segments, eradication of malware, and careful reintroduction of systems to production environments.

With the complexity in today's enterprise infrastructure and dependence on multi-cloud, the security industry is focused on improving both the capabilities and automation of the visibility and threat detection and security outcomes provided in a Security operations Center (SoC). Current solutions are dependent on the use of analytics, such as harvesting vast amount data and metadata from the network, data centers and cloud instances, their control plane, configurations, as well as other security events. In general, current analytics techniques are achieved by utilizing a centralized service that produces a security outcome. The security outcome is then used by either a human (user) using the SoC service, or by an API (e.g., such as at a policy decision point to provide an actionable to be executed by an enforcement point).

To improve threat detection efficacy, service providers may attempt to provide convergence of services, such as security information and event management (SIEM), security orchestration, automation, and response (SOAR) and/or security event detection services (eg., such as Cisco's extended detection and response (XDR)). However, doing so in a way that is scalable is difficult due to the sheer volume of security data that is received, as well as the use of centralized data lakes and a central repository to store the security data. For instance, the current storage requirements for logs of security events and security event data (e.g., telemetry data) is overwhelming and costly to maintain and process. In addition, detecting adverse security events and getting a full picture of the security landscape driven using a combination of the logging and security events incurs a time penalty due to the need to wait for a large number of events to arrive at a centralized entity, be stored, curated, and analyzed. Then, once analyzed, typically it results in a security event that is “bridged” between solutions to be acted upon by the appropriate enforcement points. Accordingly, security events may not be addressed efficiently, which can result in networks vulnerability.

Additionally, there is a very large volume of raw telemetry data which existing techniques are unable to harvest, in part due to the limitations of the sheer volume of data available. This, in turn, can generate a large volume of alerts. Thus, existing techniques have limited visibility because of the limitations of the data it can consume as well thus reducing the efficacy of detections.

Further existing techniques may provide a centralized means to process logs and security events to yield responses to potential security outcomes. However, such techniques are detached from the remediation and/or enforcement steps, thereby lacking the ability to efficiently remediate adverse security events and/or enforce network policies.

Moreover, existing techniques may utilize a hierarchical architecture, where nodes may communicate with other nodes at different levels of the hierarchy. As security events and security event data is passed up the hierarchy towards the centralized entity, the computational complexity of processing the logs, detecting security events increases. Accordingly, performing these functions at the centralized entity uses a large amount of resources and incurs a high computation load, placing a large processing and memory burden on the central entity.

The techniques described herein are directed to systems and methods for performing federated distributed security analytics via a swarm system. For instance, the system may include receiving, by a first engine of a node, event data associated with security events and/or telemetry data from one or more other nodes in the network. The system may include determining, by the first engine, a subset of data of the event data that meets one or more criteria. The system may include generating, by the first engine, a security signal associated with the subset of data. The system may include receiving, by a second engine of the node and from the first engine, the security signal as input. The system may include determining, by the second engine and based in part on the security signal, to perform an action with regard to a security event associated the security signal. The system may include outputting, by the second engine and to a second node within the network, instructions to perform the action.

In some examples, the system reimagines and merges the network controls and security analytics problems described above. For instance, processing event data and/or telemetry data, detecting event(s), and performing remediation may be viewed as a computation that is dynamically mapped to a set of nodes that are spread from the edge or co-resident with the security event source through layers of aggregation to a central node set. In some examples, nodes at each layer may have very different compute budgets and capabilities, some are extremely constrained, while others' capabilities have a decided temporal component. Rather than have identical instances of a software framework, the system may leverage a set of framework modules, each optimized for the target node's capabilities, but able to be assigned to handle a quanta/unit of the overall computation.

In some examples, the system may include a swarm node instance that comprises a transformation component and a control plane component. The transformation component may be configured to operate in the transformation layer of the swarm node instance. In some examples, the transformation component may comprise a block configuration (e.g., such as a transformation block). The transformation block may comprise analytics code and/or a machine learning algorithm. In some examples, the transformation block may be configured to perform a type of function. For instance, the type of function may comprise one or more of a hardware accelerated pipeline (e.g., such as NVIDIA's Morpheus pipeline, transformer model, autoencoder model, etc.), Bayesian or other classifiers, statistical or heuristic approaches, pattern matching algorithms, and/or machine learning models. The transformation component may be configured to receive data from one or more data feeds, where the data feeds stream directly to the transformation component from a source (e.g., such as a telemetry source, a user device, a network device, etc.). The transformation component may be configured to apply the type of function to the data and generate outputs. For instance, outputs from a transformation component at a first level of the swarm system may comprise transformed event data, outputs from a transformation component at a second level may comprise observation data, outputs from a transformation component at a third level may comprise alert data. The outputs may be sent to peer nodes at the same level and/or between level(s) (e.g., co-located node(s)), remote node(s) (e.g., such as node(s) at different level(s) of the swarm system), and/or an administrator device. The transformation component may also be configured to generate event data. As described in greater detail below, the event data may be output to the control plane component of the same swarm node instance. The event data may comprise security signal data, an identifier associated with a particular set of event(s) and/or data source, etc. In some examples, node(s) at different levels of the system may comprise transformation components that perform the same overall function (e.g., “thinning” of events) in different ways and/or using different types of technologies. For instance, at the edge level, the transformation component may utilize pattern matching. However, as transformed data moves between the different levels of the system, the transformation components may “thin” the input(s) using other types of technologies (e.g., machine learning model(s), heuristic approaches, etc.). In some examples, the transformation component may be configured to apply a machine learning model to determine anomalous behavior. For instance, the transformation component may determine the anomalous behavior associated with the event(s) based on a sequence of events and/or context around a particular event.

In some examples, the security events may comprise network-based event(s) and/or other behavior-based event(s) (e.g., such as behavior and/or changes associated with process(es)). In some examples, the security events may include range of security events with a range of confidence values, from validated security events down to essentially raw telemetry data (which could be viewed as potential security events). In some examples, the transformed For instance, the swarm node instance may not know the confidence values associated with the security events when they are initially received as input. However, when the swarm node instance performs the analysis, including compositing or enriching of the security events that are output by the transformation component, a subset of the security events received as input may be promoted to (e.g., categorized as) security and/or threat events in the outputs.

The control plane component may be configured to operate in a control plane of the swarm node instance. For instance, the control plane component may operate in parallel to the transformation component. In some examples, the control plane component may correspond to an event engine that is loaded with a specific computation graph definition to execute at run time. For instance, an administrator of the system may select and/or modify the computation graph for each node, set of node(s), etc. The control plane component may be configured to coordinate with other control plane component(s) operating on peer node(s) and/or node(s) in other level(s) of the system to carry out overall analytics and mitigation of event(s). For instance, the control plane component may comprise a state machine that includes a set of state transitions represented by the computation graph. The control plane component may receive input(s) including event data from the transformation component, security signal(s) and/or event(s) from peer control plane component(s), and/or signal(s) from remote node(s) (e.g., node(s) in upper layer(s) of the system. The control plane component may determine, based on the input(s), whether to perform one or more actions. For instance, the action(s) may correspond to a particular state of the computation graph. In some examples, the action(s) may include one or more of informing one or more peer control plane component(s) of an observed event and/or set of event(s), performing a remediation action (e.g., moving IP address(es) to new, secure connection, alerting a primary node, etc.) based on a severity associated with a particular event, performing an enforcement action (e.g., isolate a particular node, block a connection, etc.) based on accessing a security and/or network policy, and/or informing an upper layer of control plane component(s) about an event and/or set of event(s). In some examples, the action may comprise accumulating event(s) for a period of time. In some examples, the severity may be based on a configured policy of the network, a type of event (e.g., MITRE attack type, phishing type, etc.), a set of observed events, or any suitable type of event). For instance, a severity associated with an event may not reach a threshold level requiring an alert or remediation/enforcement action to be needed. In this example, the control plane component may continue to collect event data associated with the event for a period of time. Where the event data received within the period of time exceeds the threshold (e.g., causing the control plane component to transition to a state that indicates remediation/enforcement action is needed), the control plane component may then take action. For instance, a single event may not be associated with a severity (indicated by the configured policy) that requires remediation/enforcement action. However, by accumulating event data over time, the control plane component may observe that the event data indicates that a series of coordinates events have occurred that correspond to a particular type of attack (e.g., such as a MITRE attack). In this example, the control plane component may generate and output instructions to perform the remediation/enforcement action. For instance, the remediation/enforcement action may include instructing peer node(s), lower level node(s), and/or the source node to block communication(s) with one or more IP addresses. In some examples, such as where the event data does not reach the threshold level within the period of time, the control plane component may age out the event data, thereby “resetting” the state and preventing the event data from accumulating indefinitely. Accordingly, the control plane component may be configured to maintain a minimal contextual state to determine the next set of actions which could be either or both remediation, direction to collect or observer further or direct other nodes.

In some examples, the control plane component may provide input to the transformation component that is part of the same swarm node instance. For instance, the control plane component may provide event data associated with a signal received from peer control plane component(s) to the transformation component, in order to determine if the event data is associated with a particular identifier, classifier, type of event, etc.

In some examples, the transformation component and/or control plane component(s) 110 may each be optimized based on a particular node's capabilities. For instance, the transformation component and/or control plane component(s) may be assigned to a particular node and/or swarm level based on the node(s) ability handle a quanta/unit of the overall computation and/or ability to perform a particular function and/or computational task. Accordingly, the techniques may leverage the different compute budgets and capabilities of nodes at and within each level of the swarm system to provide optimized and federated processing and mitigation performance.

While some of the techniques are described herein as being performed by a security incident system implemented by a network device, some or all of the techniques may be performed by other devices and/or implemented as part of a cloud-based service. Further, while the techniques are described with respect to utilizing machine learning models, any type of models may be used (e.g., large language model(s), small language model(s), etc.). That is, other types of AI language models capable of performing the tasks described herein may be utilized herein.

While the examples described herein describe the system providing “subsets” of input security event data as output, it is understood that the system may enrich and output all of the event data received as input as well.

In this way, the swarm system may implement a swarm architecture that provides federated and distributed processing of events. By utilizing node instances that include transformation components and control plane components, the techniques may prevent the creation or use of a data lake by enabling distributed processing of complex tasks and reduced storage of telemetry data. Moreover, by implementing and using different techniques within the transformation components at different level(s) of the system, the techniques may coordinate output(s) across levels, process event data, such that a centralized entity receives a subset of events that has little to no “noise”, thereby reducing computational complexity, resource usage, and memory requirements by databases and the central entity of the system. Moreover, the subset of events may comprise enriched data such that the system is able to provide improved context to the implications of what the events provide (e.g., such as a severity of the event, indicating the set of events implicate a potential threat, etc.). That is, by breaking up the need to process all of the data by the central entity and performing different types of specialized functions at each level of the swarm system, the techniques may reduce the signal to noise ratio and generate observation data that is enriched and can lead to more accurate and earlier detections and remediation/enforcement of adverse security events, such as by providing a contextual mapping of what the data is detecting and/or observing. Further, by utilizing the distributed processing, the techniques reduce the computational load of the central entity, thereby reducing the memory and processing burden of the system.

Additionally, by enabling nodes to behave as analytic transformational blocks, the techniques may provide earlier detection of security events that may also be acted upon by its co-located security or network element. For instance, by utilizing federated processing at nodes, the techniques may reduce storage of telemetry data and logs, thereby preventing the creation or reliance on a centralized data lake. Further, by utilizing federated processing at nodes closer to the source of a security event, the techniques may identify adverse security events earlier and may remediate the security event more quickly, thereby improving network security. For instance, by enabling a node to perform remediation/enforcement action without waiting for a central entity (e.g., such as a controller) to receive and process the data and send instructions back down the architecture, the techniques described herein may reduce the time it takes to perform remediation and/or enforcement at a source node by reducing the number of nodes data needs to pass through. For instance, the techniques may enable the system to perform remediation and/or enforcement locally, more quickly, and closer to the offending device. Moreover, by reducing the computational complexity, the techniques may enable node(s) and a centralized entity to perform computations faster, thereby improving processing capabilities of the network devices.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

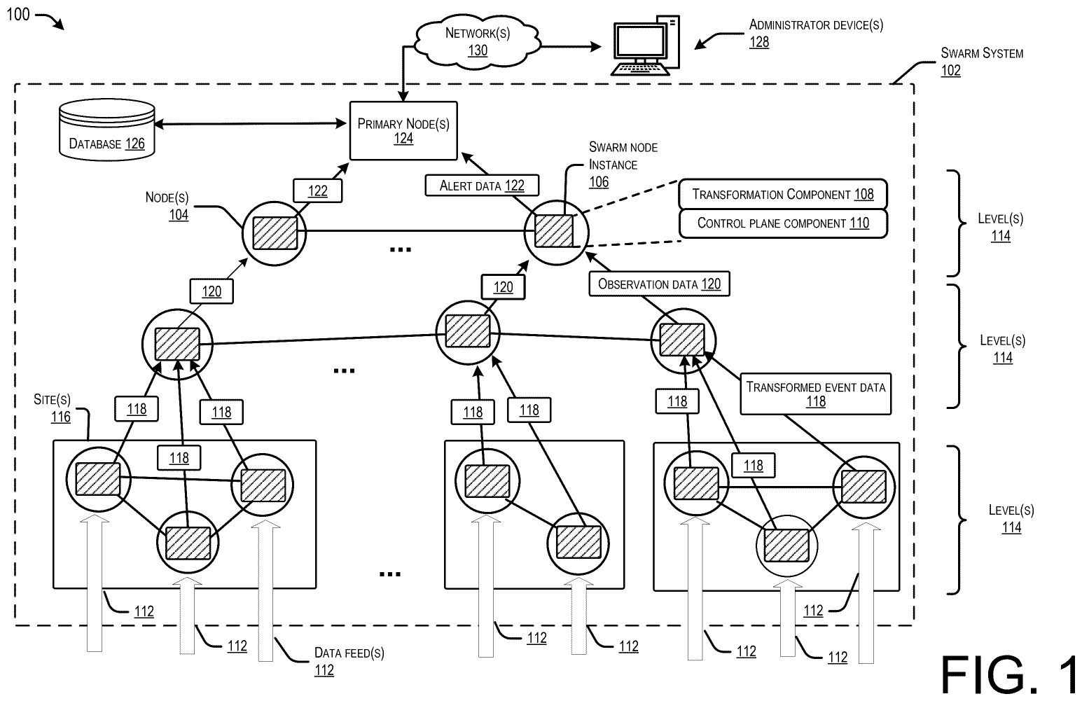

FIG. 1 illustrates a system-architecture diagram of an environment 100 in which a swarm system 102 may perform federated analytics and remediation, according to the techniques described herein.

The environment 100 may include a swarm system 102. The swarm system 102 may correspond to an architecture comprising node(s) 104 configured to communicate with peer node(s) (e.g., node(s) at a same level 114 within the architecture) and/or node(s) in other level(s) 114 of the architecture. Each of the node(s) 104 may comprise a network device (e.g., such as routers, switches, gateways, firewalls, smart NICs, NICs, ASICs, FPGAs, servers, and/or any other type of device). The node(s) 104 may each comprise memory that executes a swarm node instance 106. A swarm node instance 106 may comprise a transformation component 108 and a control plane component 110.

Transformation component 108 may be configured to operate in the transformation layer of the swarm node instance 106. In some examples and as described in greater detail below, the transformation component may comprise a block configuration that includes analytics code. The block may comprise one or more of a hardware accelerated pipeline (e.g., such as NVIDIA's Morpheus pipeline, transformer model, autoencoder model, etc.), Bayesian or other classifiers, statistical or heuristic approaches, pattern matching algorithms, and/or machine learning models. The transformation component 108 may be configured to receive data from one or more data feeds 112, where the data feeds 112 stream directly to the transformation component 108 from a source (e.g., such as a telemetry source, a user device, a network device, etc.). The transformation component 108 may be configured to apply the type of function to the data and generate outputs. For instance, outputs from a transformation component 108 at a first level of the swarm system may comprise transformed event data 118. Outputs from a transformation component at a second level may comprise observation data 120, and outputs from a transformation component at a third level may comprise alert data 122. The outputs may be sent to peer nodes (e.g., co-located node(s)) and/or remote node(s) (e.g., such as node(s) at different level(s) of the swarm system. The transformation component 108 may also be configured to generate event data (e.g., derived signal data such as local security signals). As described in greater detail below, the event data may be output to the control plane component 110 of the same swarm node instance.

Control plane component 110 may be configured to operate in the control plane of the swarm node instance 106. In some examples, the control plane component 110 may correspond to a state flow control plane (e.g., such as a state flow swarm engine) configured to maintain a state delegated to this swarm node to act and make decisions based on the inputs received from other nodes (swarm or other feeds) along with the outcomes of the transformation component, where the decisions are also guided the configuration of the actions (like policies and rules) that are configured within the control plane component 110.

For instance, the control plane component may operate in parallel to the transformation component. In some examples, the control plane component may correspond to an event engine that is loaded with a specific computation graph definition to execute at run time. For instance, an administrator of the system may select and/or modify the computation graph for each node, set of node(s), etc. The control plane component may be configured to coordinate with other control plane component(s) operating on peer node(s) and/or node(s) in other level(s) of the system to carry out overall analytics and mitigation of event(s). For instance, the control plane component may comprise a state machine that includes a set of state transitions represented by the computation graph. The control plane component may receive input(s) including event data from the transformation component, security signal(s) and/or event(s) from peer control plane component(s), and/or signal(s) from remote node(s) (e.g., node(s) in upper layer(s) of the system. As described in greater detail below, the control plane component 110 may determine, based on the input(s), whether to perform one or more actions. For instance, the action(s) may correspond to a particular state of the computation graph. In some examples, the action(s) may include one or more of informing one or more peer control plane component(s) of an observed event and/or set of event(s), perform a remediation action based on a configured policy for a particular event, and/or inform an upper layer of control plane component(s) about an event and/or set of event(s). In some examples, the action may comprise accumulating event(s) for a period of time and/or aging out the event data. In some examples, the control plane component 110 may provide input to the transformation component that is part of the same swarm node instance. For instance, the control plane component may provide event data associated with a signal received from peer control plane component(s) to the transformation component, in order to determine if the event data is associated with a particular identifier, classifier, type of event, etc. In some examples, the control plane component 110 may generate and output additional enriched security signals as well as events directly or through other systems to perform mitigation activities. The enriched security signals may be routed up the level(s) 114 of nodes either level by level, or to a primary node 124 (e.g., such as a controller or primary swarm node instance configured to interact with database 126 and/or administrator device(s) 128) of the swarm system 102. In some examples, the primary node 124 may represent a remote swarm agent configured to interact with the database 126 in order to log and/or process logged security events. In some examples, the primary node 124 and/or any of the node(s) 104 may communicate with administrator device(s) 128 to receive and send instruction(s), resource data, update(s), etc. to node(s) either level by level and/or directly.

In some examples, each of the level(s) 114 may represent a set of swarm node instance(s) that are configured with transformation component(s) 108 that perform a type of specialized function and/or control plane component(s) 110 configured to execute a particular computation graph definition. For instance, a first level may comprise a first set of nodes executing first swarm node instance(s) 106 with transformation component(s) configured to perform a first type of function (e.g., such as a pattern matching function). The first swarm node instance(s) 106 may further include control plane component(s) 110 executing a first type of computational graph. In this example, a second level may comprise a second set of nodes executing second swarm node instance(s) 106 with transformation component(s) 108 configured to perform a second type of function (e.g., such as a machine learning model, heuristic approach, etc.). The second swarm node instance(s) 106 may further include control plane component(s) 110 executing a second type of computational graph. In some examples, the level(s) 114 of the swarm system 102 may represent set(s) of node(s) within a mesh architecture, a swarm architecture, or any other suitable architecture type. While the illustrated swarm system 102 may be described as a mesh architecture herein, it is understood that the techniques are not limited to a mesh architecture and may be implemented in a hierarchical architecture, non-hierarchical architecture, or any other suitable network architecture.

The swarm node instance(s) 106 and/or node(s) 104 may be configured to communicate with each other. For instance, node(s) 104 within a same level of the swarm system 102 may communicate with peer node(s) (e.g., node(s) within the same level and/or implementing the same type of function within the transformation component 108 and/or control plane component 110). Additionally, the node(s) 104 may communicate with node(s) in other level(s) 114 (e.g., upper level nodes, primary node(s) 124, lower level nodes, etc.).

In some examples, the data received by node(s) 104 within each level is “thinned” (e.g., filtered, transformed) into a subset of data input to the node(s) at the level prior. For instance, the data feed(s) 112 input to the edge level node(s) at site(s) 116 may comprise event data, telemetry data, alert data, etc. In some examples, the data feed(s) 112 comprise data describing conditions of interest associated with security events. By applying the first type of function in the first level of the swarm system, the first set of node(s) may output the transformed event data 118. The transformed event data may comprise a subset of events that include a classifier defined by the type of function implemented on the first set of node(s). The second level may receive the transformed event data 118 as input and generate observation data 120 as output. The observation data 120 may comprise a subset of observed events from the transformed event data that correspond to a particular classifier defined by the type of transformation component 108 defined for the second level. The third level may receive the observation data 120 as input and generate alert data 122 as output to the primary node 124. The alert data 122 may include security event(s) of a particular severity level, requiring administrator review and/or approval, etc. The primary node(s) may be configured to store and/or log alert data 122 and/or corresponding event(s) in database 126 (e.g., such as Splunk). Accordingly, as security events pass through each level of the swarm system 102, the “noise” associated with the events is thinned out. Further, while transformation component(s) 108 at each level may perform a same type of function, the output(s) and/or classifier(s) identified by the transformation component(s) 108 within each level may be different based on the source(s) of the data feed(s) 112. Moreover, as event(s) get “thinned”, the system can perform a variety of different action(s) based on the thinned set of observation(s) (e.g., via the control plane component(s) 110). In some examples, “thinning” can be performed to enable the system to enrich the transformed data, such that the system can better categorize (either in clustering or categorizing/classifying) the events so that they are more meaningful (e.g., from a MITRE TTP set of descriptions).

For instance, in some examples, the swarm node instance(s) 106 may generate output(s), such as generating a “security outcome.” The “security outcome” may comprise a security event which can represent an “observed procedure or technique” based on the MITRE attack framework.

The environment 100 may include a network(s) 130. The network(s) 130 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The network(s) 130 may include devices, virtual resources, or other nodes that relay packets from one network segment to another by nodes in the computer network. The network(s) 130 may include multiple devices that utilize the network layer (and/or session layer, transport layer, etc.) in the OSI model for packet forwarding, and/or other layers. The network(s) 130 may include various network device(s), such as routers, switches, gateways, firewalls, smart NICs, NICs, ASICs, FPGAs, servers, and/or any other type of device. Further, the network(s) 130 may include virtual resources, such as VMs, containers, and/or other virtual resources. However, the network(s) 130 may be of a different type of architecture, such as a WAN, IoT network, cellular network, or any other type of network.

In some examples, one or more of the node(s) 104 may be located at one or more site(s) 116. The one or more site(s) 116 may represent one or more data centers, which may be physical facilities or buildings located across geographic areas that designated to store networked devices that are part of the network(s) 130. The data centers may include various networking devices, as well as redundant or backup components and infrastructure for power supply, data communications connections, environmental controls, and various security devices. In some examples, the data centers may include one or more virtual data centers which are a pool or collection of cloud infrastructure resources specifically designed for enterprise needs, and/or for cloud-based service provider needs. Generally, the data centers (physical and/or virtual) may provide basic resources such as processor (CPU), memory (RAM), storage (disk), and networking (bandwidth). However, in some examples the devices may not be located in explicitly defined data centers, but may be located in other locations or buildings. In some examples, the data center(s) may represent a security operations center of a service provider (e.g., such as Cisco).

In some examples, the site(s) 116 may represent an edge level of the service network implementing the swarm system 102. The swarm system 102 may be configured to receive data feed(s) 112. As illustrated node(s) 104 and/or swarm node instance(s) 106 may receive data feeds 112 at a first level (e.g., the edge level). For instance, a data feed 112 may stream directly into a transformation component 108 of a swarm node instance 106 at the first level. The data feed(s) 112 may comprise telemetry data, including security event data, alert(s), etc. The transformation component(s) 108 of the swarm node instance(s) 106 at the first level may perform a first type of function on the data included in the data feeds to generate transformed event data 118.

In some examples, the transformation component 108 and/or control plane component(s) 110 may each be optimized based on a particular node's capabilities. For instance, the transformation component 108 and/or control plane component(s) 110 may be assigned to a particular node and/or swarm level based on the node(s) 104 ability handle a quanta/unit of the overall computation and/or ability to perform a particular function and/or computational task. Accordingly, the techniques may leverage the different compute budgets and capabilities of nodes at and within each level of the swarm system to provide optimized and federated processing and mitigation performance.

In this way, the swarm system 102 may implement a swarm architecture that provides federated and distributed processing of events. By utilizing node instances that include transformation components and control plane components, the techniques may prevent the creation or use of a data lake by enabling distributed processing of complex tasks and reduced storage of telemetry data. Moreover, by implementing and using different techniques within the transformation components at different level(s) of the system, the techniques may coordinate output(s) across levels, process event data, such that a centralized entity receives a subset of events that has little to no “noise”, thereby reducing computational complexity, resource usage, and memory requirements by databases and the central entity of the system. Additionally, by enabling nodes to behave as analytic transformational blocks, the techniques may provide earlier detection of security events that may also be acted upon by its co-located security or network element. For instance, by utilizing federated processing at nodes, the techniques may reduce storage of telemetry data and logs, thereby preventing the creation or reliance on a centralized data lake. Further, by utilizing federated processing at nodes closer to the source of a security event, the techniques may identify adverse security events earlier and may remediate the security event more quickly, thereby improving network security. For instance, by enabling a node to perform remediation/enforcement action without waiting for a central entity (e.g., such as a controller) to receive and process the data and send instructions back down the architecture, the techniques described herein may reduce the time it takes to perform remediation at a source node by reducing the number of nodes data needs to pass through. Moreover, by reducing the computational complexity, the techniques may enable node(s) and a centralized entity to perform computations faster, thereby improving processing capabilities of the network devices. Further, the architecture is highly scalable, such that the system may be applied across customer networks.

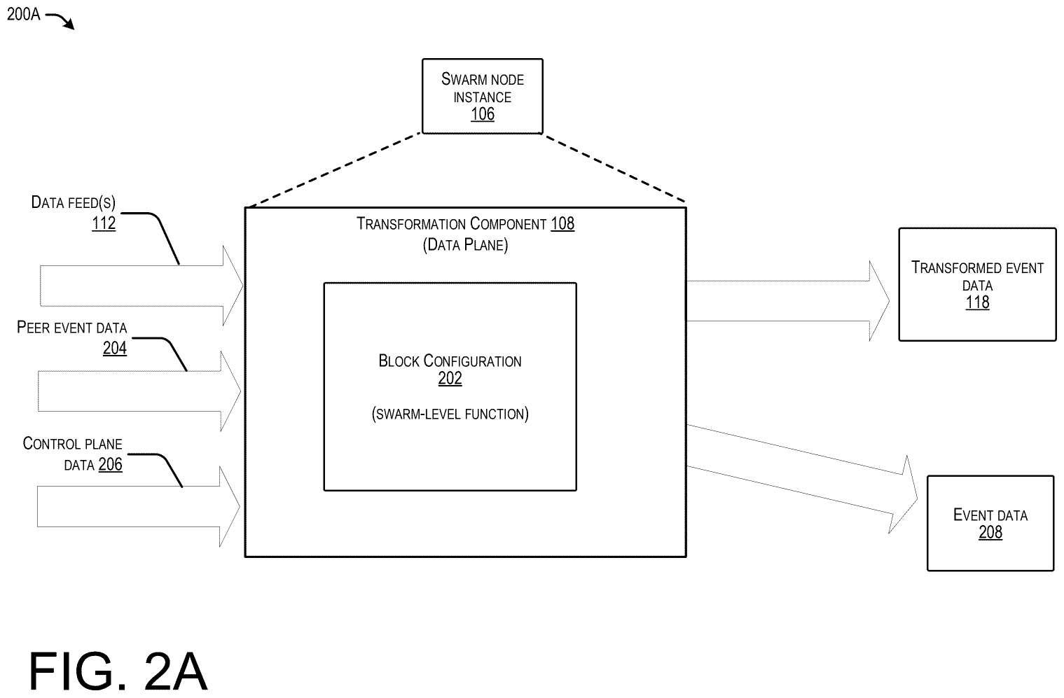

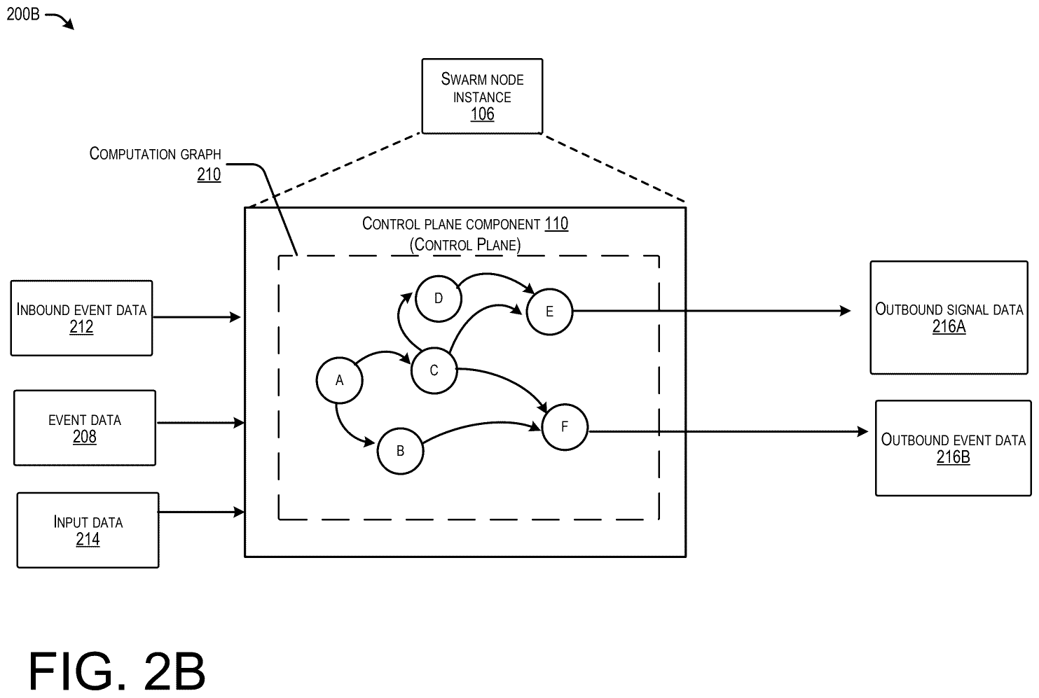

FIGS. 2A and 2B illustrate example environments showing exemplary input(s) and output(s) of component(s) of a swarm node instance 106, according to the techniques described herein. It is understood that the example input(s) and output(s) illustrated in FIGS. 2A and 2B are not limiting, and that additional, fewer, and/or alternative input(s) and/or output(s) may be used.

FIG. 2A illustrates an example environment 200A including example input(s) and output(s) of a transformation component 108 of the swarm node instance 106, according to the techniques described herein. For instance, the example environment 200A may correspond to a transformation component 108 of a swarm node instance 106 located at an edge level of the swarm system 102. As illustrated, the environment 200A includes swarm node instance 106, data feed(s) 112, transformation component 108, and transformed event data 118.

As illustrated in environment 200A, the transformation component 108 may be configured to operate within a data plane of a node 104. Additionally, the transformation component 108 may include block configuration 202. The block configuration 202 may comprise a transformation block configured to perform a swarm-level function. For instance, at the edge level of the swarm system 102, the block configuration 202 may be configured to perform a Bayesian type function and/or a pattern matching type function on input data. In some examples, the block configuration 202 may include a transformation surround layer that is configured to present externally and/or provide transformation services. For instance, the transformation surround layer may interface between the core processing functionality of the block configuration and all other service(s). As noted above, the type of function implemented by the block configuration 202 may be swarm level specific. For instance, a level's function may correspond to the same classifier (e.g., such as a neural network, a hardware accelerated pipeline (e.g., such as NVIDIA's Morpheus pipeline, transformer model, autoencoder model, etc.), Bayesian classifier(s), statistical approach, pattern matching algorithm, heuristic approach, or any other suitable classifier). Moreover, between level(s) 114 of the swarm system 102, the block configuration 202 may be configured with a different classifier (e.g., such as machine learning model or engine), one that is specific to the particular level.

In some examples, the output(s) of the transformation component(s) 108 within the same level 114 of the swarm system may comprise different results. For instance, where the block configuration 202 is configured to perform a pattern matching type of function, the outputs of the block configuration 202 may include a first signature set based on the network device(s) providing the data feed(s) 112. A second transformation component executing on a second node at the same level of the swarm system may also execute a pattern matching type of function. However, the second transformation component may generate a different signature set mased on the network device(s) it receive(s) data feed(s) 112 from. In some examples, the

As illustrated, input(s) to the transformation component 108 may include receiving data from data feed(s) 112 directly, such as via a stream or other communication. The transformation component 108 may also receive event data 208 as input. Event data 208 may comprise signature(s) associated with event(s) detected by transformation component(s) of peer swarm node instance(s) (e.g., node(s) executing the same swarm-level function). For instance, the event data 208 may comprise a subset of event(s) included in data feed(s) 112 received by the peer swarm node instance(s). For instance, the event data 208 may comprise transformed event data 118 from peer swarm node instance(s) (e.g., co-located node(s)). The transformation component 108 may also be configured to receive control plane data 206. For instance, the control plane data 206 may comprise an input from the control plane component 110 of the same swarm node instance 106. The input may include data associated with event(s) the control plane component 110 has received input from peer(s) and/or other level(s) of node(s).

In some examples, such as where the swarm-level function of the block configuration 202 is to perform a pattern matching type function, the transformation component may generate transformed event data 118 that includes event(s) from data feed(s) 112 that trigger a particular signature (e.g., such as a signature defined by the pattern matching algorithm). Event(s) that do not trigger one or more signature(s) may be identified as “noise” and excluded (e.g., dropped) from the transformed event data 118 and/or peer event data. In another example, such as where the swarm-level function comprises a machine learning model and/or engine, the transformation component 108 may include an event within the transformed event data 118 based on determining that the event meets or exceeds a threshold probability of being interesting (e.g., a severity level, potentially part of a MITRE attack, etc.). In this example, event(s) that are below the threshold may be identified as “noise” and excluded from the transformed event data 118, event data 208, etc.

In some examples, the transformation component 108 may also generate event data 208. Event data 208 may comprise security signal(s) and/or identifier associated with an event, set of event(s), and/or source of the event(s).

Accordingly, the transformation component 108 may receive input data streams (e.g., data feed(s) 112, peer event data 204, control plane data 206) and generate two classes of output: (1) transformed event data 118 (e.g., a processed version of the input stream(s) that includes a subset of the event(s)) that is output to other transformation component(s) (e.g., co-located/peer node(s) and/or upper level node(s)) and (2) event data 208 (e.g., a security signal that is derived from the telemetry stream) that is output to the control plane component 110 of the same swarm node instance.

FIG. 2B illustrates an example environment 200B including example input(s) and output(s) of a control plane component 110 of the swarm node instance 106, according to the techniques described herein. In some examples, the control plane component 110 illustrated in environment 200B may be executing on a same swarm node instance 106 as the transformation component 108 of FIG. 2A. In some examples, the control plane component comprises an event engine that is loaded at start time with a particular computation graph 210. In some examples, the control plane component 110 may be configured to instantiate the transformation component that are part of the same swarm node instance 106. In some examples, the control plane component may be configured to communicate with a remote swarm agent to discover resource(s) at start time and/or during operation to mitigate changes in the environment of the control plane component. In some examples, the control plane component 110 may be configured to set up the data feed(s) 112 and/or connections to other level(s) 114.

As illustrated, the environment 200B includes swarm node instance 106, control plane component 110, and event data 208. The control plane component 110 may be configured to operate in a control plane of a node and may comprise computation graph 210. As described herein the computation graph 210 may represent a set of states that the control plane component 110 may transition to based on received input(s). Each state may correspond to and/or cause the control plane component to perform one or more actions. For instance, as input(s) are received, the control plane component may transition between states “a”, “b”, “c”, “d”, “e”, and “f.” When the state reaches “e” and/or “f”, the control plane component may be configured to generate output(s). In some examples, the computation graph 210 is instantiated at runtime and defined by a network administrator. In some examples, the computation graph 210 executing by a control plane component 110 may be a swarm-level graph and/or may be different from graph(s) executing on peer swarm node instance(s). Accordingly, the computation graph 210 may be fully customizable by the network administrator.

The control plane component 110 may be configured to receive input(s) including event data 208, inbound event data 212, and/or input data 214. For instance, as described herein, event data 208 may be received from the transformation component 108. Inbound event data 212 may comprise security signals associated with set(s) of event(s) from other control plane component(s) (e.g., co-located control plane component(s), upper level control plane component(s), etc.). In some examples, the inbound event data 212 may comprise instructions to perform an action associated with an event. For instance, the action may include communicating with a process (e.g., such as a firewall service) that is co-located with a particular peer control plane component to remediate a particular session (e.g., such as an IP source and IP destination couple) and move the session to a different VLAN connection. The input(s) may also include input data 214, which may comprise instructions and/or commands received from a network and/or event(s) input by a network administrator.

As illustrated, the control plane component may generate output(s) including outbound signal data 216A and/or outbound event data 216B (referred to collectively as outbound signal and event data 216). In some examples, the outbound signal data 216A may comprise data including security signal(s) sent to other control plane component(s) within the swarm system. For instance, the control plane component 110 may output the outbound signal data 216A to inform peer(s) or upper level node(s) of security event(s) and/or action(s) taken by the control plane component 110. As described herein, the control plane component 110 may also generate output and/or provide output to the transformation component 108.

In some examples, the outbound event data 216B may comprise instructions to perform an action associated with an event, such as instructions to remediate an event. For instance, the outbound event data 216B may be sent to peer control plane components and/or source node(s) in lower level(s) of the swarm system. Thus, the control plane component may work in concert with other control plane components to carry out analytic functions of the system, as well as performing mitigation functions.

As an example, the control plane component 110 may determine, based on the input(s), whether to perform one or more actions. For instance, the action(s) may correspond to a particular state of the computation graph. In some examples, the action(s) may include one or more of informing one or more peer control plane component(s) of an observed event and/or set of event(s), perform a remediation action based on a configured policy for a particular event, and/or inform an upper layer of control plane component(s) about an event and/or set of event(s). In some examples, the action may comprise accumulating event(s) for a period of time. For instance, the configured policy may include a severity (e.g., type of threat, etc.) associated with a particular event that requires an action. The severity associated with an event may not reach a threshold level requiring an alert or remediation/enforcement action to be needed. In this example, the control plane component may continue to collect event data associated with the event for a period of time. Where the event data received within the period of time exceeds the threshold (e.g., causing the control plane component to transition to a state that indicates a remediation/enforcement action is needed), the control plane component may then take action. For instance, a single event may not be associated with a severity that requires remediation/enforcement action. However, by accumulating event data over time, the control plane component may observe that the event data indicates that a series of coordinates events have occurred that correspond to a particular type of attack (e.g., such as a MITRE attack). In this example, the control plane component may generate and output instructions to perform the remediation/enforcement action. For instance, the remediation/enforcement action may include instructing peer node(s), lower level node(s), and/or the source node to block communication(s) with one or more IP addresses. In some examples, such as where the event data does not reach the threshold level within the period of time, the control plane component may age out the event data, thereby “resetting” the state and preventing the event data from accumulating indefinitely.

In some examples, the control plane component 110 may be configured to provide updates to the transformation component 108, data feed(s) received by the transformation component, etc. based on input data 214.

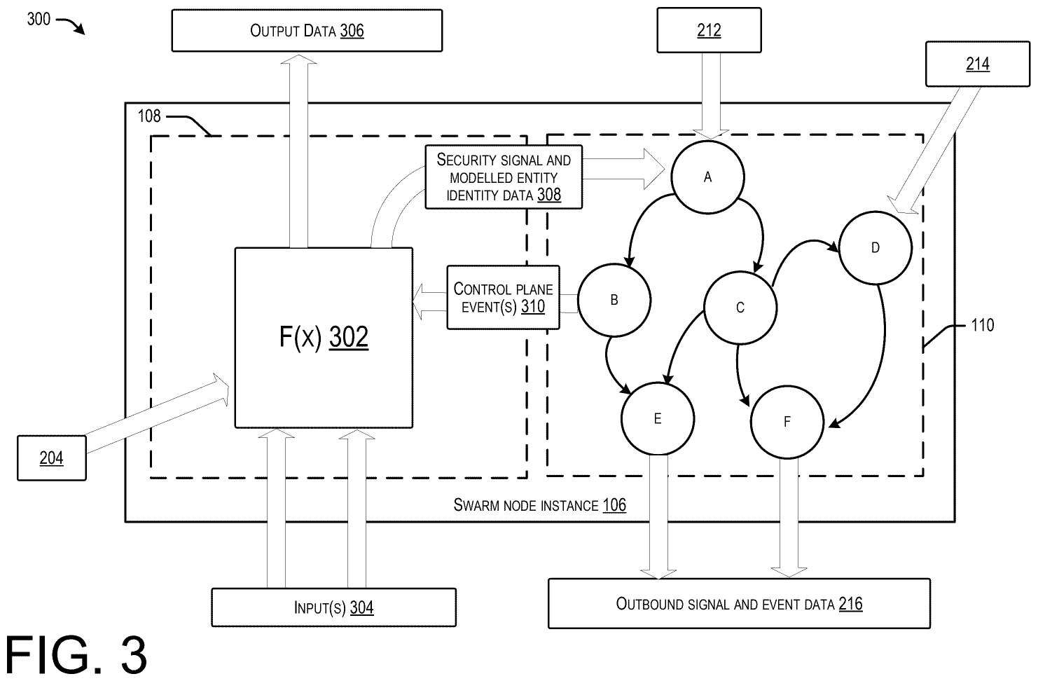

FIG. 3 illustrates an example environment 300 showing input(s) and output(s) of component(s) of a node, according to the techniques described herein. As illustrated, the environment 300 includes node 104, transformation component 108, control plane component 110, data feed(s) 112, peer event data 204, inbound event data 212, input data 214, and outbound signal and event data 216.

Environment 300 further includes function (e.g., f(x) 302) as part of the transformation component 108. The f(x) 302 may represent the type of function performed by the block configuration 202 described herein. As noted above, the f(x) 302 and/or block configuration 202 may correspond to a classifier (e.g., a neural network, a hardware accelerated pipeline (e.g., such as NVIDIA's Morpheus pipeline, transformer model, autoencoder model, etc.), Bayesian classifier(s), pattern matching algorithm(s), statistical approach, heuristic approach, etc.). In some examples, such as where f(x) 302 comprises a neural network, the neural network may be trained to perform a specific type of function. As illustrated, the f(x) 302 may receive input(s) 304 and peer event data 204. In some examples, input(s) 304 may be received from node(s) 104 at a lower level of the swarm system 102 described herein and/or from other source(s), such as network device(s), user device(s), etc. For instance, input(s) 304 may comprise data feed(s) 112, transformed event data 118, observation data 120, alert data 122, and/or any other data described herein. F(x) 302 may additionally receive peer event data 204 and/or control plane event(s) 310 as input. F(x) 302 may aggregate the input and perform the type of function.

As illustrated, the f(x) 302 may generate two classes of output. For instance, the f(x) 302 may generate a first class comprising output data 306, which may comprise a processed version of the input(s) 304. The output data 306 may include a subset of the input(s) 304, where any “noise” identified in the input(s) is excluded. For instance, output data 306 may comprise transformed event data 118, observation data 120, alert data 122, etc. In some examples, the output data 306 may be sent to other transformation components of other node(s) in the swarm system 102, such as peer node(s) and/or upper level node(s). In some examples, the output data 306 may correspond to an output stream and/or connection that is configured by the control plane component 110. The f(x) 302 may generate a second class of output comprising security signal and modelled entity identity data 308. The security signal and modelled entity identity data 308 may comprise derived security signal(s) from the input(s) and/or an identifier associated with a source entity of the input(s) and/or event associated with the derived security signal(s). For instance, the security signal and modelled entity identity data 308 may include an identifier of an event that is determined to be suspicious. The security signal and modelled entity identity data 308 may be output and provided to the control plane component 110 as an input.

In some examples, the control plane component 110 may output control plane event(s) 310 to the transformation component 108. The control plane event(s) 310 may comprise an event and/or data the control plane component 110 received as an input. For instance, the control plane component may receive inbound event data 212 comprising an event that occurred at a peer. The control plane component 110 may request the transformation component analyze the event by providing the event to the transformation component as input (e.g., as control plane data 206). In this example, the transformation component 108 may aggregate the event with other input events and may determine if it is suspicious, such as by applying f(x) 302.

The control plane component 110 may be configured to receive the security signal and modelled entity identity data 308, inbound event data 212, and input data 214 as inputs. As illustrated the security signal and modelled entity identity data 308 and inbound event data 212 may be provided to a first state (e.g., state “A”) of the computation graph, whereas input data may be provided to a second state (e.g., state “D”) of the computation graph. The control plane component 110 may determine whether to act upon the inputs (e.g., security signals and identifier(s)) based on the computation graph loaded at instantiation time.

In some examples, the control plane component 110 may output additional enriched security signals as well as events (e.g., outbound signal and event data 216) directly or through other systems to perform mitigation activities, as described herein. In some examples, the outbound signal and event data 216 (e.g., such as the enriched security signals) may be routed up the swarm system level by level, or to a distinguished node much deeper in the network.

In some examples, the control plane component 110 may receive signals or events that result in the update of its companion transformation component's 108 classifier (Neural Net) and/or input stream end points. In this example, the control plane component 110 may instruct and/or update the transformation component 108. In some examples, outbound signal and event data 216 may result in a new computation graph being loaded in other control plane components in the swarm system 102 (e.g., either peer node(s) or other node(s)).

As an example, and not by way of limitation, the f(x) 302 of the transformation component 108 may be configured as a pattern matching engine. In this example, the transformation component 108 may be configured to receive input(s) 304 from one or more source(s). When the transformation component 108 identifies an event matching a particular signature, the transformation component may generate the security signal and modelled entity identity data 308 associated with the signature and output the data to the control plane component 110. In this example, the security signal and modelled entity identity data 308 may comprise a set of observations associated with the signature. The control plane component may receive the security signal and modelled entity identity data 308 as input and may initially (e.g., as part of state “A”) generate a set of related events based on the signature (e.g., such as a unique device identifier associated with the source of the security event). Accordingly, the control plane component 110 may continue to receive input(s) and may group together data that is received from the transformation component and includes the unique device identifier. The control plane component 110 may then analyze the observation data associated with the unique device identifier. For instance, the observation data may indicate whether a particular type of attack or technique is used or associated with the security event. The control plane component 110 may determine an action to take based on the observation data. For instance, the control plane component 110 may comprise a computation graph configured to follow phases of an attack (e.g., such as a MITRE attack). In this example, as the control plane component 110 receives additional input associated with the unique identifier, the computation graph may move to different state(s) (e.g., “C”, “D”, etc.) associated with a different phase of the MITRE attack. Once the computation graph reaches a particular state, one or more action(s) may be triggered (e.g., such as generating outbound signal and event data 216). In an example, such as where no additional input is received for a pre-defined period of time, the control plane component 110 may age out the observation data and/or unique identifier associated with the security event and may reset the “state” of the attack. In some examples, the security signal and modelled entity identity data 308 may indicate that a particular security event is associated with an attack comes in and is above a severity threshold (indicated by a policy) indicating an action needs to take place to remediate. In this example, the remediation action may be based on the stage of attack and/or state the computation graph is in when the particular security event is received. For instance, the control plane component 110 may walk through a set of states in the computation graph, that will result in the control plane component performing a mitigation action for the particular security event. For instance, the mitigation action may include generating and sending instructions to another node, the source device, etc. in order to cause the other node to block a connection, shut a node down, or any other action. The mitigation action may also include generating and sending an alert the upper layer node(s) and/or directly to a remote node, such as primary node 124. After performing the action, the control plane component 110 may return to the state it was tracking for that particular unique identifier prior to the particular security event being received.

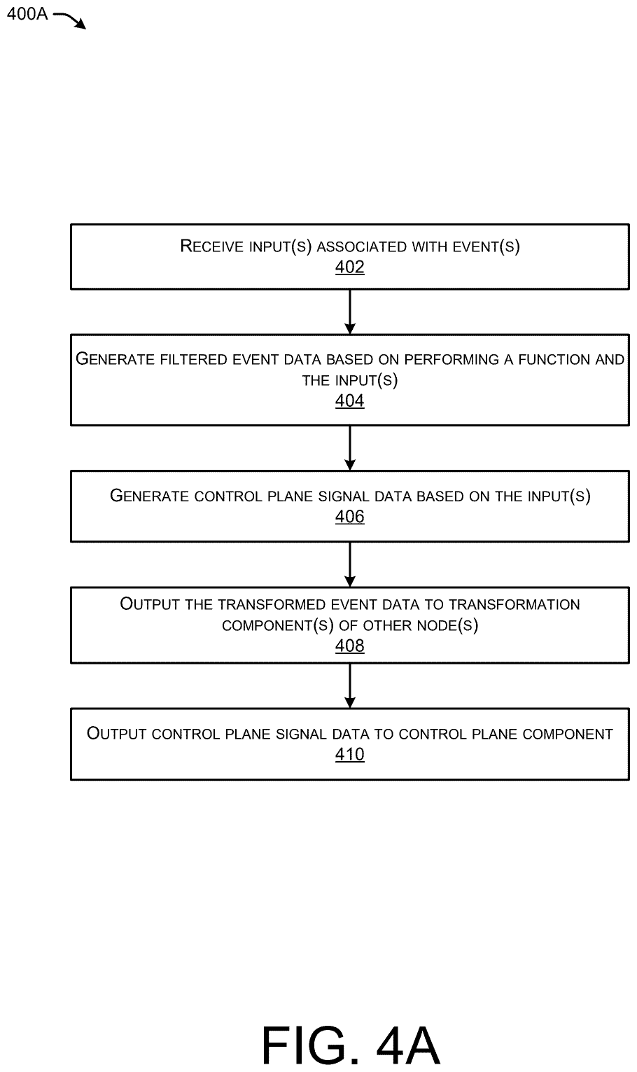

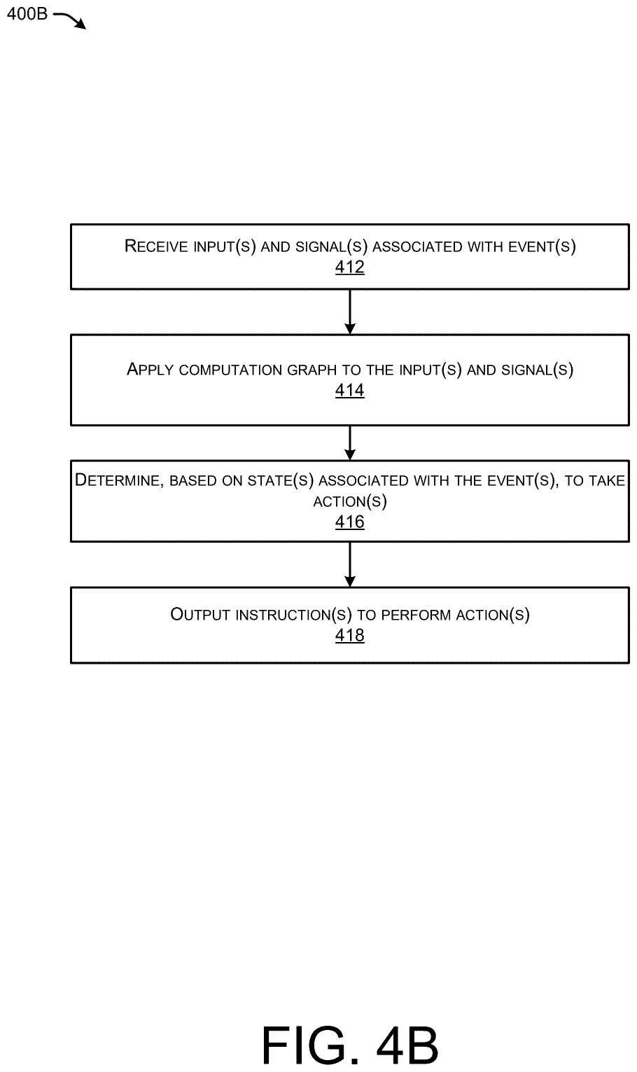

FIG. 4A illustrates an example process 400A for transforming event data, according to the techniques described herein. In some examples, the example process 400A may be performed by a transformation component 108 of a swarm node instance 106 within a swarm system 102.

At 402, the process 400A may include receiving input(s) associated with event(s). For instance, a transformation component 108 may receive input(s) from telemetry streams (e.g., data feed(s) 112), node(s) at a lower level of the swarm system 102, transformation components of peer node(s), and/or a control plane component 110 of the same swarm node instance 106.

At 404, the process 400A may include generating transformed event data based on performing a function and the input(s). For instance, the transformed event data may correspond to output data 306, as described herein, the transformed event data may comprise a subset of event(s) included in the input(s), where the event(s) in the subset meet criteria defined by the function.

At 406, the process 400A may include generating control plane signal data based on the input(s). For instance, the process 400A may generate security signal and modelled entity identity data 308 based on the input(s), where the control plane signal data includes data associated with one or more security events (e.g., such as observation data, attack type, etc.) as well as a unique identifier of the one or more security event(s). The unique identifier may be associated with a source of the security event(s) (e.g., a particular site, a particular network device, an IP address, a user identifier, a subnet, or any other suitable identifier).

At 408, the process 400A may include outputting the transformed event data to transformation component(s) of other node(s). For instance, the process 400A may output the transformed event data to transformation component(s) of peer node(s) and/or transformation component(s) of node(s) at other level(s) 114 of the swarm system.

At 410, the process 400A may include outputting the control plane signal data to the control plane component. For instance, the control plane signal data may be output to the control plane component 110 of the same swarm node instance 106.

FIG. 4B illustrates an example process 400B for control plane processing, according to the techniques described herein. In some examples, the example process 400B may be performed by a control plane component 110 of a swarm node instance 106 within a swarm system 102.

At 412, the process 400B may include receiving input(s) and signal(s) associated with event(s). For instance, the process 400B may receive input(s) from a network administrator, control plane component(s) of peer node(s) and/or other node(s) (e.g., upper and/or lower level node(s)) of the swarm system 102, and/or the transformation component 108. The event(s) may comprise security event(s) occurring across network(s) 130.

At 414, the process 400B may include applying a computation graph to the input(s) and signal(s). For instance, the process 400B may instantiate a computation graph 210 at run time and input the input(s) and signal(s) to the computation graph 210.

At 416, the process 400B may include determining, based on state(s) associated with the event(s), to take action(s). For instance, the process 400B may transition to a state that is associated with an action. The action(s) may include mitigation actions, aggregating and observing events, informing peer node(s), etc.

At 418, the process 400B may include outputting instruction(s) to perform the action(s). For instance, the process 400B may generate and output instructions to peer node(s), lower level node(s), source(s) of the adverse security event, etc. In some examples, the process may output instructions and/or an alert to a remote swarm agent (e.g., such as a primary node 124) in order to alert the network administrator.

Accordingly, the swarm node instance(s) 106 may utilize processes 400A and 400B to behave as transformational blocks that provide early detection of adverse security events by the transformation component 108 and perform mitigation action(s) by the control plane component 110.

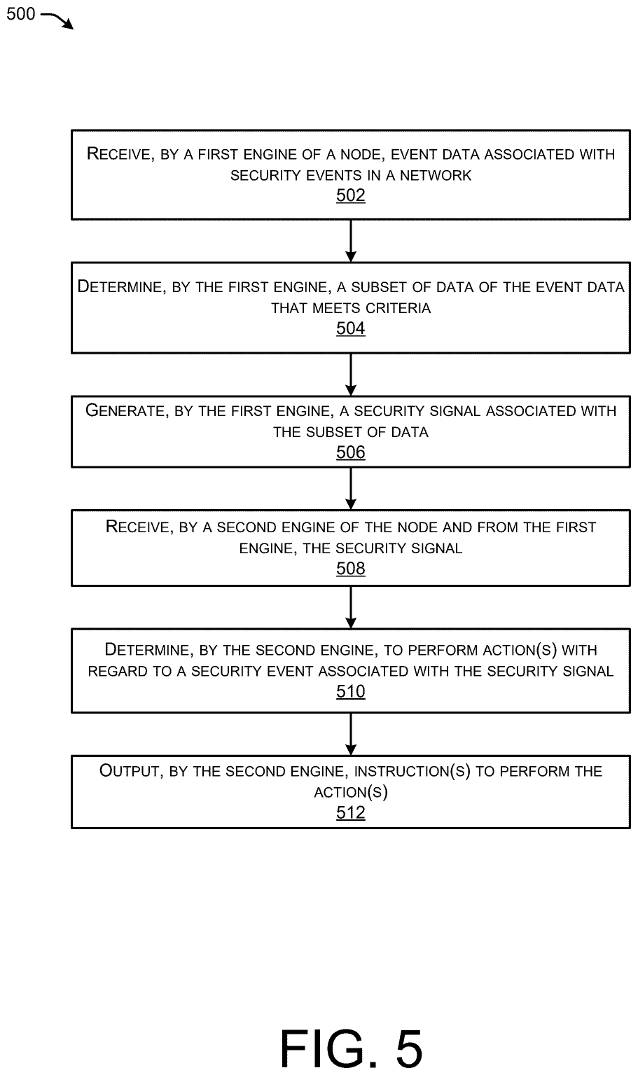

FIG. 5 illustrates a flow diagram of an example system 500 implementing a process to perform federated analytics according to the techniques described herein. One or more steps of the system 500 may be performed by one or more computing devices, such as node(s) 104 of the swarm system 102. Implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in FIG. 5 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

At 502, the system may receive, by a first engine of a node, event data associated with security events in a network. In some examples, the network may comprise a mesh network. For instance, the node may comprise a swarm node instance 106, where the first engine corresponds to transformation component 108. The event data (e.g., security event data and/or raw telemetry data) may be received from other node(s) of the network (e.g., such as other swarm nodes, peer nodes, etc.) or sensors or other sources of event data. In some examples, the event data may be received from a source device (e.g., computing device of a user, endpoint, etc.).

At 504, the system may determine, by the first engine, a subset of data of the event data that meets criteria. For instance, the system may determine the subset of data is suspicious based on performing a specialized type of function. The system may determine that the subset of data corresponds to a particular security event and/or unique identifier. In some examples, the subset of data may include observation data, alert data, transformed event data, etc. based on the first engine receiving and analyzing the event data. For instance, the system may identify one or more anomalies associated with one or more security event(s) within the event data. The system may include the one or more anomalies as part of the subset of data. In some examples, the specialized type of function may comprise a pattern matching function, a machine learning function, heuristic function, a Bayesian function, a neural network function.

At 506, the system may generate, by the first engine, a security signal associated with the subset of data. In some examples, the node may be included as part of a first level of a swarm system of the network. In some examples, first nodes within the first level of the swarm system comprise first engines configured to execute a first type of specialized function, and the one or more second nodes within a second level of the swarm system comprise first engines configured to execute a second type of specialized function that is different from the first type.

In some examples, the system may additionally include generating, by the first engine and based on executing a specialized type of function using the event data as input, transformed event data associated with a portion of the security events that comprise a particular identifier or classifier defined by the specialized type of function. The system may include outputting, by the first engine and to one or more nodes at a second level within the network, the transformed event data. Accordingly, the first engine may be configured to generate two classes of data that are each output to different entities.

At 508, the system may receive, by a second engine of the node and from the first engine, the security signal. In some examples, the second engine comprises a control plane engine that is configured to execute a level specific computation graph. For instance, the second engine may represent control plane component 110. The level specific computation graph may comprise computation graph 210. In some examples, the level specific computation graph is selected by an administrator of the network and loaded into the second engine at runtime. As described herein, the second engine may be configured to instantiate the first engine at runtime and/or configure connection(s) and/or input source(s) (e.g., data feed(s) 112, node(s) 104, etc.) of the first engine. In some examples, the second engine may be configured to communicate a remote swarm agent (e.g., such as a primary node).

At 510, the system may determine, by the second engine, to perform action(s) with regard to a security event associated with the security signal. In some examples, the action comprises one or more of: informing peer nodes of the security event; performing a remediation or enforcement action based on a preconfigured policy determined for the security event; accumulating security signals associated with the security event, wherein subsequent security signals received in association with the security event may trigger action at a subsequent time; informing upper layer nodes of the security event; or informing an upper layer controller. In some examples, the second engine may determine the action further based on one or more of: first inputs associated with security events from one or more peer nodes; second inputs from one or more nodes associated with a different level within the network; or third inputs from an administrator of the network. In some examples, the preconfigured policy may include a severity of the threat, the severity comprising a threat or attack type, threshold number of event(s), etc.

At 512, the system may output, by the second engine, instruction(s) to perform the action(s). For instance, the second engine may output the instruction(s) to peer node(s), other node(s) within the swarm system, source(s), etc. In some examples, the output may be sent to enforcement point(s) within the network infrastructure (e.g., a particular service, firewall, gateway, or other enforcement point).

In some examples, the second engine may be configured to output security events to one or more first engines of the node. For instance, the second engine may represent the control plane component, and the first engine may represent a transformation component (e.g., such as a transformation block). In this example, the control plane component may be configured to provide outputs to the data plane and/or in the data path. For instance, the control plane component may route security events to one or more transformation components that comprise a swarm node. Accordingly, in some examples, the control plane component may be configured to curate the incoming data and route events, based upon the event type to specific transformation blocks within the network. In some examples, the control plane component may receive input(s) from multiple sources. For instance, the control plane component may be configured to receive input(s) from lower-level swarm nodes directly. In this example, the control plane component may process, classify, and/or filter the input(s) (e.g., such as security events) before routing the security event(s) to a transformation block.

In some examples, the event data may comprise events associated with process behavior. For instance, the event data may comprise events that are not limited to network-based events. As an example, the event data may be generated in response to change(s) in process(es), file changes, permission changes, access changes to facilities (e.g., such as registry access on windows). Accordingly, the system may analysis process behavior in order to categorize behavior and infer intent.

Accordingly, techniques may implement a swarm architecture that provides federated processing of logs and security events. By utilizing node instances that include transformation components and control plane components, the techniques may prevent the creation or use of a data lake by enabling distributed processing of complex tasks and reduced storage of telemetry data. Moreover, by implementing and using different techniques within the transformation components at different level(s) of the system, the techniques may coordinate output(s) across levels, process event data, such that a centralized entity receives a subset of events that has little to no “noise”, thereby reducing computational complexity, resource usage, and memory requirements by databases and the central entity of the system. That is, by breaking up the need to process all of the data by the central entity and performing different types of specialized functions at each level of the swarm system, the techniques may reduce the signal to noise ratio and generate observation data that can lead to more accurate and earlier detections and remediation/enforcement of adverse security events. Further, by utilizing the distributed processing, the techniques reduce the computational load of the central entity, thereby reducing the memory and processing burden of the system.

Additionally, by enabling nodes to behave as analytic transformational blocks, the techniques may provide earlier detection of security events that may also be acted upon by its co-located security or network element. For instance, by utilizing federated processing at nodes, the techniques may reduce storage of telemetry data and logs, thereby preventing the creation or reliance on a centralized data lake. Further, by utilizing federated processing at nodes closer to the source of a security event, the techniques may identify adverse security events earlier and may remediate the security event more quickly, thereby improving network security. For instance, by enabling a node to perform remediation/enforcement action without waiting for a central entity (e.g., such as a controller) to receive and process the data and send instructions back down the architecture, the techniques described herein may reduce the time it takes to perform remediation and/or enforcement at a source node by reducing the number of nodes data needs to pass through. For instance, the techniques may enable the system to perform remediation and/or enforcement locally, more quickly, and closer to the offending device. Moreover, by reducing the computational complexity, the techniques may enable node(s) and a centralized entity to perform computations faster, thereby improving processing capabilities of the network devices.

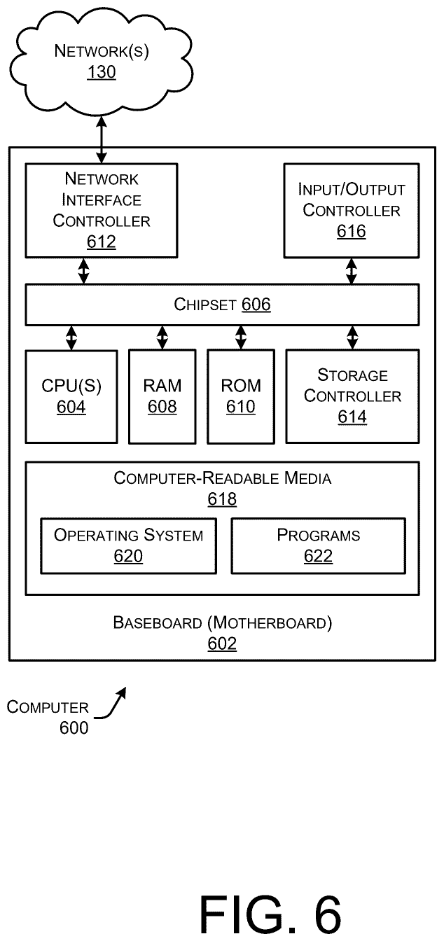

FIG. 6 shows an example computer architecture for a device capable of executing program components for implementing the functionality described above. The computer architecture shown in FIG. 6 illustrates any type of computer 600, such as a conventional server computer, workstation, desktop computer, laptop, tablet, network appliance, e-reader, smartphone, or other computing device, and can be utilized to execute any of the software components presented herein.

As described herein, the swarm system 102 may be run on the computer 600, or multiple computers. Similarly, the computer 600 may be any type of device, such as network device(s). Thus, the computer 600 may, in some examples, correspond to any device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 600 includes a baseboard 602, or “motherboard,” which is a printed circuit board to which a multitude of components or devices can be connected by way of a system bus or other electrical communication paths. In one illustrative configuration, one or more central processing units (“CPU(s) 604”) operate in conjunction with a chipset 606. The CPU(s) 604 can be standard programmable processors that perform arithmetic and logical operations necessary for the operation of the computer 600.

The CPU(s) 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPU(s) 604 and the remainder of the components and devices on the baseboard 602. The chipset 606 can provide an interface to a RAM 608, used as the main memory in the computer 600. The chipset 606 can further provide an interface to a computer-readable storage medium such as a read-only memory (“ROM”) 610 or non-volatile RAM (“NVRAM”) for storing basic routines that help to startup the computer 600 and to transfer information between the various components and devices. The ROM 610 or NVRAM can also store other software components necessary for the operation of the computer 600 in accordance with the configurations described herein.

The computer 600 can operate in a networked environment using logical connections to remote computing devices and computer systems through a network, such as the network(s) 130. The chipset 606 can include functionality for providing network connectivity through a NIC 612, such as a gigabit Ethernet adapter. The NIC 612 is capable of connecting the computer 600 to other computing devices over the network(s) 130. It should be appreciated that multiple NICs 612 can be present in the computer 600, connecting the computer to other types of networks and remote computer systems.

The computer 600 can be connected to a storage device 618 that provides non-volatile storage for the computer. The storage device 618 can store an operating system 620, programs 622, and data, which have been described in greater detail herein. The storage device 618 can be connected to the computer 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computer 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 600 can further read information from the storage device 618 by detecting the physical states or characteristics of one or more particular locations within the physical storage units.

In addition to the mass storage device 618 described above, the computer 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 600. In some examples, the operations performed by the swarm system 102, and or any components included therein, may be supported by one or more devices similar to computer 600. Stated otherwise, some or all of the operations performed by swarm system 102 and/or the swarm node instance(s) 106, and or any components included therein, may be performed by one or more computer devices (e.g., such as computer 600).

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computer 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computer 600.

In one embodiment, the storage device 618 or other computer-readable storage media is encoded with computer-executable instructions which, when loaded into the computer 600, transform the computer from a general-purpose computing system into a special-purpose computer capable of implementing the embodiments described herein. These computer-executable instructions transform the computer 600 by specifying how the CPU(s) 604 transition between states, as described above. According to one embodiment, the computer 600 has access to computer-readable storage media storing computer-executable instructions which, when executed by the computer 600, perform the various processes described above with regard to FIGS. 1-5. The computer 600 can also include computer-readable storage media having instructions stored thereupon for performing any of the other computer-implemented operations described herein.

The computer 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computer 600 might not include all of the components shown in the Figures, can include other components that are not explicitly shown in FIG. 6, or might utilize an architecture completely different than that shown in FIG. 6.

As described herein, the computer 600 may comprise one or more of an swarm system 102, and/or any other device. The computer 600 may include one or more hardware processors (e.g., processor(s), such as CPU(s) 604) configured to execute one or more stored instructions. The processor(s) may comprise one or more cores. Further, the computer 600 may include one or more network interfaces configured to provide communications between the computer 600 and other devices, such as the communications described herein as being performed by the swarm system 102 and/or the swarm node instance(s) 106. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 622 may comprise any type of programs or processes to perform the techniques described in this disclosure.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method implemented by nodes of a network, comprising:
receiving, by a first engine of a node, event data associated with security events from one or more other nodes in the network;
determining, by the first engine, a subset of data of the event data that meets one or more criteria;
generating, by the first engine, a security signal associated with the subset of data;
receiving, by a second engine of the node and from the first engine, the security signal as input;
determining, by the second engine and based in part on the security signal, to perform an action with regard to a security event associated the security signal; and
outputting, by the second engine and to a second node within the network, instructions to perform the action.

2. The method of claim 1, wherein the node is included as part of a first level within a swarm system of the network, further comprising:
generating, by the first engine and based on executing a specialized type of function using the event data as input, transformed event data associated with a portion of the security events that comprise a particular identifier or classifier defined by the specialized type of function; and
outputting, by the first engine and to one or more nodes at a second level within the network, the transformed event data.

3. The method of claim 2, wherein the specialized type of function comprises one of a pattern matching function, a machine learning function, heuristic function, a Bayesian function, a neural network function.

4. The method of claim 2, wherein:
first nodes within the first level of the swarm system comprise one or more first engines configured to execute a first type of specialized function, and
one or more second nodes within the second level of the swarm system comprise one or more first engines configured to execute a second type of specialized function that is different from the first type.

5. The method of claim 1, wherein the second engine comprises a control plane engine that is configured to execute a level specific computation graph that is selected by an administrator of the network and loaded into the second engine at runtime.

6. The method of claim 1, wherein the second engine comprises a control plane engine and is configured to:
receive one or more inputs via one or more pathways of the network, the one or more inputs including security events;
perform processing, classification, or filtering of the security events to generate an output;
determine an event type associated with the output; and
route the output to a particular first engine within the network based on the event type.

7. The method of claim 1, wherein the action comprises one or more of:
informing peer nodes or other nodes of the security event;
performing a remediation or enforcement action based on a configured policy determined for the security event;
accumulating security signals associated with the security event, wherein subsequent security signals received in association with the security event may trigger action at a subsequent time;
informing upper layer nodes of the security event; or
informing an upper layer controller.

8. The method of claim 1, wherein the second engine determines the action further based on one or more of:
first inputs associated with additional security events from one or more peer nodes;
second inputs from one or more nodes associated with a different level within the network; or
third inputs from an administrator of the network.

9. The method of claim 1, wherein the second engine is configured to instantiate the first engine at runtime.

10. A system comprising:
one or more processors; and
one or more non-transitory computer-readable media that, when executed by the one or more processors, cause the one or more processors to perform operations comprising:
receiving, by a first engine of a node, event data associated with security events from one or more other nodes in a network;
determining, by the first engine, a subset of data of the event data that meets one or more criteria;
generating, by the first engine, a security signal associated with the subset of data;
receiving, by a second engine of the node and from the first engine, the security signal as input;
determining, by the second engine and based in part on the security signal, to perform an action with regard to a security event associated the security signal; and
outputting, by the second engine and to a second node within the network, instructions to perform the action.

11. The system of claim 10, wherein the node is included as part of a first level within a swarm system of the network, the operations further comprising:
generating, by the first engine and based on executing a specialized type of function using the event data as input, transformed event data associated with a portion of the security events that comprise a particular identifier or classifier defined by the specialized type of function; and
outputting, by the first engine and to one or more nodes at a second level within the network, the transformed event data.

12. The system of claim 11, wherein the specialized type of function comprises one of a pattern matching function, a machine learning function, heuristic function, a Bayesian function, a neural network function.

13. The system of claim 11, wherein:
first nodes within the first level of the swarm system comprises first engines configured to execute a first type of specialized function, and
one or more second nodes within the second level of the swarm system comprise first engines configured to execute a second type of specialized function that is different from the first type.

14. The system of claim 10, wherein the second engine comprises a control plane engine that is configured to execute a level specific computation graph that is selected by an administrator of the network and loaded into the second engine at runtime.

15. The system of claim 10, wherein the second engine comprises a control plane engine and is configured to:
receive one or more inputs via one or more pathways of the network, the one or more inputs including security events;
perform processing, classification, or filtering of the security events to generate an output;
determine an event type associated with the output; and
route the output to a particular first engine within the network based on the event type.

16. The system of claim 10, wherein the action comprises one or more of:
informing peer nodes or other nodes of the security event;
performing a remediation or enforcement action based on a configured policy determined for the security event;
accumulating security signals associated with the security event, wherein subsequent security signals received in association with the security event may trigger action at a subsequent time;
informing upper layer nodes of the security event; or
informing an upper layer controller.

17. The system of claim 10, wherein the second engine determines the action further based on one or more of:
first inputs associated with additional security events from one or more peer nodes;
second inputs from one or more nodes associated with a different level within the network; or
third inputs from an administrator of the network.

18. The system of claim 10, wherein the second engine is configured to instantiate the first engine at runtime.

19. One or more non-transitory computer-readable media storing instructions executable by one or more processors of a node, wherein the instructions, when executed, cause the one or more processors to perform operations comprising:
receiving, by a first engine of the node, event data associated with security events from one or more other nodes in a network implementing a swarm system;
determining, by the first engine, a subset of data of the event data that meets one or more criteria;
generating, by the first engine, a security signal associated with the subset of data;
receiving, by a second engine of the node and from the first engine, the security signal as input;
determining, by the second engine and based in part on the security signal, to perform an action with regard to a security event associated the security signal; and
outputting, by the second engine and to a second node within the network, instructions to perform the action.

20. The one or more non-transitory computer-readable media of claim 19, wherein the node is included as part of a first level within the swarm system of the network, the operations further comprising:
generating, by the first engine and based on executing a specialized type of function using the event data as input, transformed event data associated with a portion of the security events that comprise a particular identifier or classifier defined by the specialized type of function; and
outputting, by the first engine and to one or more nodes at a second level within the network, the transformed event data.
